(19) United States
(12) Patent Application Publication
(10) Pub. No.: US 2012/0238028 A1
(43) Pub. Date: Sep. 20, 2012

(54) Means and Methods for Diagnosing Multiple Sclerosis

(75) Inventors: Regina Reszka, Panketal (DE); Ulrike Rennefahrt, Berlin (DE); Andreas Hewelt, Berlin (DE); Jürgen Kastler, Berlin (DE); Jens Fuhrmann, Berlin (DE); Frauke Zipp, Mainz (DE); Carmen Infante-Duarte, Berlin (DE)

(73) Assignee: Metanomics Health GmbH, Berlin (DE)

(21) Appl. No.: 13/513,021

(22) PCT Filed: Nov. 30, 2010
(86) PCT No.: PCT/EP2010/068508

§ 371 Date: May 31, 2012

Related U.S. Application Data
(60) Provisional application No. 61/294,119, filed on Jan. 12, 2010.
(60) Provisional application No. 61/345,170, filed on May 17, 2010.

(30) Foreign Application Priority Data
Dec. 1, 2009 (EP) 09177622.9
May 11, 2010 (EP) 10162572.1

(51) Int. Cl. G01N 27/62

(52) U.S. Cl. 436/71; 436/86

(57) ABSTRACT

The present invention relates to the field of diagnostic methods. Specifically, the present invention contemplates a method for diagnosing multiple sclerosis in a subject, a method for identifying whether a subject is in need for a therapy of multiple sclerosis or a method for determining whether a multiple sclerosis therapy is successful. Moreover, contributed is a method for diagnosing or predicting the risk of an active status of multiple sclerosis in a subject. The invention also relates to tools for carrying out the aforementioned methods, such as diagnostic devices.

The present invention relates to the field of diagnostic methods. Specifically, the present invention contemplates a method for diagnosing multiple sclerosis in a subject, a method for identifying whether a subject is in need for a therapy of multiple sclerosis or a method for determining whether a multiple sclerosis therapy is successful. Moreover, contributed is a method for diagnosing or predicting the risk of an active status of multiple sclerosis in a subject. The invention also relates to tools for carrying out the aforementioned methods, such as diagnostic devices.

Multiple sclerosis (MS) affects approximately 1 million individuals worldwide and is the most common disease of the central nervous system (CNS) that causes prolonged and severe disability in young adults. Although its etiology remains elusive, strong evidence supports the concept that a T cell-mediated inflammatory process against self molecules within the white matter of the brain and spinal cord underlies its pathogenesis. Since myelin-reactive T cells are present in both MS patients and healthy individuals, the primary immune abnormality in MS most likely involves failed regulatory mechanisms that lead to an enhanced T cell activation status and less stringent activation requirements. Thus, the pathogenesis includes activation of encephalitogenic, i.e. autoimmune myelin-specific T cells outside the CNS, followed by: an opening of the blood-brain barrier; T cell and macrophage infiltration; microglial activation; demyelination, and irreversible neuronal damage (Aktas 2005, Neuron 46, 421-432, Zamvil 2003, Neuron 38:685-688 or Zipp 2006, Trends Neurosci. 29, 518-527). While much is known about the mechanisms responsible for the encephalitogenicity of T cells, little is known as yet regarding the body's endogenous control mechanisms for regulating harmful lymphocyte responses into and within the CNS. In addition, despite extensive studies on T-cell mediated demyelination, the damage processes in vivo within the CNS are not fully understood.

Currently, diagnostic tools such as neuroimaging, analysis of cerebrospinal fluid and evoked potentials are used for diagnosing MS. Magnetic resonance imaging of the brain and spine can visualize demyelination (lesions or plaques). Gadolinium can be administered intravenously as a contrast agent to mark active plaques and, by elimination, demonstrate the existence of historical lesions which are not associated with symptoms at the moment of the evaluation. Analysing cerebrospinal fluid obtained from a lumbar puncture can provide evidence of chronic inflammation of the central nervous system. The cerebrospinal fluid can be analyzed for oligoclonal bands, which are an inflammation marker found in 75-85% of people with MS (Link 2006, J Neuroimmunol. 180 (1-2): 17-28. However, none of the aforementioned techniques is specific to MS, only. Therefore, most often only biopsies or post-mortem examinations can yield a reliable diagnosis.

Since MS is a clinically highly heterogeneous inflammatory disease of the central nervous system, diagnostic and prognostic markers are needed to facilitate diagnose, predict the course of the disease in the individual patient, the necessity of treatment and the kind of therapy. The response to the currently available therapies differs from patient to patient without any evidences from the course of the disease. Markers would alleviate the choice of drug to apply, which will be even more important within the next years, when further drugs will come on the market. Furthermore, rapidly progressing patients should from the beginning be treated more aggressively than patients with a rather benign disease course. Markers of tissue damage and, in particular, neuronal damage may be only or higher expressed in patients with rapid progression and subsequent disability. On the other hand, treating the patients with an aggressive therapy with potentially devastating side effects requires therapy response markers as well as a risk management. Thus biomarkers for disease activity and response to therapy are valuable for determining the patient's prognosis, and can allow a personalized adjustment of therapy.

Accordingly, means and methods for reliably diagnosing MS and for evaluating the success of a therapy are highly desired but not yet available.

Therefore, the present invention relates to a method for diagnosing multiple sclerosis in a subject comprising the steps of:
a) determining in a sample of the subject the amount of at least one biomarker selected from the biomarkers listed in Table 1 and/or Table 2.
b) comparing the amount of the said at least one biomarker to a reference amount, whereby multiple sclerosis is to be diagnosed.

The method as referred to in accordance with the present invention includes a method which essentially consists of the aforementioned steps or a method which includes further steps. However, it is to be understood that the method, in a preferred embodiment, is a method carried out ex vivo, i.e. not practised on the human or animal body. The method, preferably, can be assisted by automation.

The term “diagnosing” as used herein refers to assessing whether a subject suffers from the disease MS, or not. As will be understood by those skilled in the art, such an assessment, although preferred to be, may usually not be correct for 100% of the investigated subjects. The term, however, requires that a statistically significant portion of subjects can be correctly assessed and, thus, diagnosed. Whether a portion is statistically significant can be determined without further ado by the person skilled in the art using various well known statistic evaluation tools, e.g., determination of confidence intervals, p-value determination, Student's t-test, Mann-Whitney test, etc. Details are found in Dowdy and Wearden, Statistics for Research, John Wiley & Sons, New York 1983. Preferred confidence intervals are at least 50%, at least 60%, at least 70%, at least 80%, at least 90%, at least 95%. The p-values are, preferably, 0.2, 0.1, 0.05.

The term includes individual diagnosis of MS or its symptoms as well as continuous monitoring of a patient. Monitoring, i.e. diagnosing the presence or absence of MS or the symptoms accompanying it at various time points, includes monitoring of patients known to suffer from MS as well as monitoring of subjects known to be at risk of developing MS. Furthermore, monitoring can also be used to determine whether a patient is treated successfully or whether at least symptoms of MS can be ameliorated over time by a certain therapy.

The term “MS (multiple sclerosis)” as used herein relates to disease of the central nervous system (CNS) that causes prolonged and severe disability in a subject suffering therefrom. The pathogenesis of MS includes activation of encephalitogenic, i.e. autoimmune myelin-specific T cells outside the CNS, followed by an opening of the blood-brain barrier, T cell and macrophage infiltration, microglial activation, demyelination, and irreversible neuronal damage. There are four standardized subtype definitions of MS which are also encompassed by the term as used in accordance with the present invention: relapsing remitting, secondary progressive, primary progressive and progressive relapsing. The relapsing-remitting subtype is characterized by unpredictable relapses followed by periods of months to years of remission with no new signs of disease activity. Deficits suffered during attacks (active status) may either resolve or leave sequelae. This describes the initial course of 85 to 90% of subjects suffering from MS. In cases of so-called benign MS the deficits always resolve between active statuses. Secondary progressive MS describes those with initial relapsing-remitting MS, who then begin to have progressive neurological decline between acute attacks without any definite periods of remission. Occasional relapses and minor remissions may appear. The median time between disease onset and conversion from relapsing-remitting to secondary progressive MS is about 19 years. The primary progressive sub-type describes about 10 to 15% of subjects who never have remission after their initial MS symptoms. It is characterized by progression of disability from onset, with no, or only occasional and minor, remissions and improvements. The age of onset for the primary progressive subtype is later than other subtypes. Progressive relapsing MS describes those subjects who, from onset, have a steady neurological decline but also suffer clear superimposed attacks. This is the least common of all subtypes. There are also some cases of atypical MS which can not be allocated in the aforementioned subtype groups.

Symptoms associated with MS include changes in sensation (hypoesthesia and paraesthesia), muscle weakness, muscle spasms, difficulty in moving, difficulties with coordination and balance (ataxia), problems in speech (dysarthria) or swallowing (dysphagia), visual problems (nystagmus, optic neuritis, or diplopia), fatigue, acute or chronic pain, bladder and bowel difficulties. Cognitive impairment of varying degrees as well as emotional symptoms of depression or unstable mood may also occur as symptoms. The main clinical measure of disability progression and symptom severity is the Expanded Disability Status Scale (EDSS).

Further symptoms of MS are well known in the art and are described in the standard text books of medicine, such as Stedman or Pschyrembl.

The term “biomarker” as used herein refers to a molecular species which serves as an indicator for a disease or effect as referred to in this specification. Said molecular species can be a metabolite itself which is found in a sample of a subject. Moreover, the biomarker may also be a molecular species which is derived from said metabolite. In such a case, the actual metabolite will be chemically modified in the sample or during the determination process and, as a result of said modification, a chemically different molecular species, i.e. the analyte, will be the determined molecular species. It is to be understood that in such a case, the analyte represents the actual metabolite and has the same potential as an indicator for the respective medical condition. Moreover, a biomarker according to the present invention is not necessarily corresponding to one molecular species. Rather, the biomarker may comprise stereoisomers or enantiomeres of a compound. Further, a biomarker can also represent the sum of isomers of a biological class of isomeric molecules. Said isomers shall exhibit identical analytical characteristics in some cases and are, therefore, not distinguishable by various analytical methods including those applied in the accompanying Examples described below. However, the isomers will share at least identical sum formula parameters and, thus, in the case of, e.g., lipids an identical chain length and identical numbers of double bonds in the fatty acid and/or sphingo base moieties.

In the method according to the present invention, at least one metabolite of the aforementioned group of biomarkers, i.e. the biomarkers as shown in Table 1 and/or Table 2, is to be determined. However, more preferably, a group of biomarkers will be determined in order to strengthen specificity and/or sensitivity of the assessment. Such a group, preferably, comprises at least 2, at least 3, at least 4, at least 5, at least 10 or up to all of the said biomarkers shown in the Tables. In addition to the specific biomarkers recited in the specification, other biomarkers may be, preferably, determined as well in the methods of the present invention.

In a preferred embodiment of the method of the invention, said at least one biomarker is selected from the group of biomarkers listed in Table 1 a and/or Table 2a. An increase in such a biomarker is indicative for multiple sclerosis.

In another preferred embodiment of the method of the present invention said at least one biomarker is selected from the group of biomarkers listed in Table 1b and/or Table 2b. A decrease in such a biomarker is indicative for multiple sclerosis.

A metabolite as used herein refers to at least one molecule of a specific metabolite up to a plurality of molecules of the said specific metabolite. It is to be understood further that a group of metabolites means a plurality of chemically different molecules wherein for each metabolite at least one molecule up to a plurality of molecules may be present. A metabolite in accordance with the present invention encompasses all classes of organic or inorganic chemical compounds including those being comprised by biological material such as organisms. Preferably, the metabolite in accordance with the present invention is a small molecule compound. More preferably, in case a plurality of metabolites is envisaged, said plurality of metabolites representing a metabolome, i.e. the collection of metabolites being comprised by an organism, an organ, a tissue, a body fluid or a cell at a specific time and under specific conditions.

The metabolites are small molecule compounds, such as substrates for enzymes of metabolic pathways, intermediates of such pathways or the products obtained by a metabolic pathway. Metabolic pathways are well known in the art and may vary between species. Preferably, said pathways include at least citric acid cycle, respiratory chain, glycolysis, gluconeogenesis, hexose monophosphate pathway, oxidative pentose phosphate pathway, production and β-oxidation of fatty acids, urea cycle, amino acid biosynthesis pathways, protein degradation pathways such as proteasomal degradation, amino acid degrading pathways, biosynthesis or degradation of: lipids, polyketides (including e.g. flavonoids and isoflavonoids), isoprenoids (including eg. terpenes, sterols, steroids, carotenoids, xanthophylls), carbohydrates, phenylpropanoids and derivatives, alcaloids, benzenoids, indoles, indole-sulfur compounds, porphyrines, anthocyans, hormones, vitamins, cofactors such as prosthetic groups or electron carriers, lignin, glucosinolates, purines, pyrimidines, nucleosides, nucleotides and related molecules such as tRNAs, microRNAs (miRNA) or mRNAs. Accordingly, small molecule compound metabolites are preferably composed of the following classes of compounds: alcohols, alkanes, alkenes, alkines, aromatic compounds, ketones, aldehydes, carboxylic acids, esters, amines, imines, amides, cyanides, amino acids, peptides, thiols, thioesters, phosphate esters, sulfate esters, thioethers, sulfoxides, ethers, or combinations or derivatives of the aforementioned compounds. The small molecules among the metabolites may be primary metabolites which are required for normal cellular function, organ function or animal growth, development or health. Moreover, small molecule metabolites further comprise secondary metabolites having essential ecological function, e.g. metabolites which allow an organism to adapt to its environment. Furthermore, metabolites are not limited to said primary and secondary metabolites and further encompass artificial small molecule compounds. Said artificial small molecule compounds are derived from exogenously provided small molecules which are administered or taken up by an organism but are not primary or secondary metabolites as defined above. For instance, artificial small molecule compounds may be metabolic products obtained from drugs by metabolic pathways of the animal. Moreover, metabolites further include peptides, oligopeptides, polypeptides, oligonucleotides and polynucleotides, such as RNA or DNA. More preferably, a metabolite has a molecular weight of 50 Da (Dalton) to 30,000 Da, most preferably less than 30,000 Da, less than 20,000 Da, less than 15,000 Da, less than 10,000 Da, less than 8,000 Da, less than 7,000 Da, less than 6,000 Da, less than 5,000 Da, less than 4,000 Da, less than 3,000 Da, less than 2,000 Da, less than 1,000 Da, less than 500 Da, less than 300 Da, less than 200 Da, less than 100 Da. Preferably, a metabolite has, however, a molecular weight of at least 50 Da. Most preferably, a metabolite in accordance with the present invention has a molecular weight of 50 Da up to 1,500 Da.

The term “sample” as used herein refers to samples from body fluids, preferably, blood, plasma, serum, saliva, urine or cerebrospinal fluid, or samples derived, e.g., by biopsy, from cells, tissues or organs, in particular from the CNS including brain and spine. More preferably, the sample is a blood, plasma or serum sample, most preferably, a plasma sample. Biological samples can be derived from a subject as specified elsewhere herein. Techniques for obtaining the aforementioned different types of biological samples are well known in the art. For example, blood samples may be obtained by blood taking while tissue or organ samples are to be obtained, e.g., by biopsy.

The aforementioned samples are, preferably, pre-treated before they are used for the method of the present invention. As described in more detail below, said pre-treatment may include treatments required to release or separate the compounds or to remove excessive material or waste. Suitable techniques comprise centrifugation, extraction, fractioning, ultrafiltration, protein precipitation followed by filtration and purification and/or enrichment of compounds. Moreover, other pre-treatments are carried out in order to provide the compounds in a form or concentration suitable for compound analysis. For example, if gas-chromatography coupled mass spectrometry is used in the method of the present invention, it will be required to derivatize the compounds prior to the said gas chromatography. Suitable and necessary pre-treatments depend on the means used for carrying out the method of the invention and are well known to the person skilled in the art. Pre-treated samples as described before are also comprised by the term “sample” as used in accordance with the present invention.

The term “subject” as used herein relates to animals and, preferably, to mammals. More preferably, the subject is a primate and, most preferably, a human. The subject, preferably, is suspected to suffer from MS, i.e. it may already show some or all of the symptoms associated with the disease.

The term “determining the amount” as used herein refers to determining at least one characteristic feature of a biomarker to be determined by the method of the present invention in the sample. Characteristic features in accordance with the present invention are features which characterize the physical and/or chemical properties including biochemical properties of a biomarker. Such properties include, e.g., molecular weight, viscosity, density, electrical charge, spin, optical activity, colour, fluorescence, chemoluminescence, elementary composition, chemical structure, capability to react with other compounds, capability to elicit a response in a biological read out system (e.g., induction of a reporter gene) and the like. Values for said properties may serve as characteristic features and can be determined by techniques well known in the art. Moreover, the characteristic feature may be any feature which is derived from the values of the physical and/or chemical properties of a biomarker by standard operations, e.g., mathematical calculations such as multiplication, division or logarithmic calculus. Most preferably, the at least one characteristic feature allows the determination and/or chemical identification of the said at least one biomarker and its amount. Accordingly, the characteristic value, preferably, also comprises information relating to the abundance of the biomarker from which the characteristic value is derived. For example, a characteristic value of a biomarker may be a peak in a mass spectrum. Such a peak contains characteristic information of the biomarker, i.e. the m/z information or mass/charge ratio (or quotient), as well as an intensity value being related to the abundance of the said biomarker (i.e. its amount) in the sample.

As discussed before, each biomarker comprised by a sample may be, preferably, determined in accordance with the present invention quantitatively or semi-quantitatively. For quantitative determination, either the absolute or precise amount of the biomarker will be determined or the relative amount of the biomarker will be determined based on the value determined for the characteristic feature(s) referred to herein above. The relative amount may be determined in a case were the precise amount of a biomarker can or shall not be determined. In said case, it can be determined whether the amount in which the biomarker is present is enlarged or diminished with respect to a second sample comprising said biomarker in a second amount. In a preferred embodiment said second sample comprising said biomarker shall be a calculated reference as specified elsewhere herein. Quantitatively analysing a biomarker, thus, also includes what is sometimes referred to as semi-quantitative analysis of a biomarker.

Moreover, determining as used in the method of the present invention, preferably, includes using a compound separation step prior to the analysis step referred to before. Preferably, said compound separation step yields a time resolved separation of the metabolites comprised by the sample. Suitable techniques for separation to be used preferably in accordance with the present invention, therefore, include all chromatographic separation techniques such as liquid chromatography (LC), high performance liquid chromatography (HPLC), gas chromatography (GC), thin layer chromatography, size exclusion or affinity chromatography. These techniques are well known in the art and can be applied by the person skilled in the art without further ado. Most preferably, LC and/or GC are chromatographic techniques to be envisaged by the method of the present invention. Suitable devices for such determination of biomarkers are well known in the art. Preferably, mass spectrometry is used in particular gas chromatography mass spectrometry (GC-MS), liquid chromatography mass spectrometry (LC-MS), direct infusion mass spectrometry or Fourier transform ion-cyclotrone-resonance mass spectrometry (FT-ICR-MS), capillary electrophoresis mass spectrometry (CE-MS), high-performance liquid chromatography coupled mass spectrometry (HPLC-MS), quadrupole mass spectrometry, any sequentially coupled mass spectrometry, such as MS-MS or MS-MS-MS, inductively coupled plasma mass spectrometry (ICP-MS), pyrolysis mass spectrometry (Py-MS), ion mobility mass spectrometry or time of flight mass spectrometry (TOF). Most preferably, LC-MS and/or GC-MS are used as described in detail below. Said techniques are disclosed in, e.g., Nissen 1995, Journal of Chromatography A, 703: 37-57, U.S. Pat. No. 4,540,884 or U.S. Pat. No. 5,397,894, the disclosure content of which is hereby incorporated by reference. As an alternative or in addition to mass spectrometry techniques, the following techniques may be used for compound determination: nuclear magnetic resonance (NMR), magnetic resonance imaging (MRI), Fourier transform infrared analysis (FT-IR), ultraviolet (UV) spectroscopy, refraction index (RI), fluorescent detection, radiochemical detection, electrochemical detection, light scattering (LS), dispersive Raman spectroscopy or flame ionisation detection (FID). These techniques are well known to the person skilled in the art and can be applied without further ado. The method of the present invention shall be, preferably, assisted by automation. For example, sample processing or pre-treatment can be automated by robotics. Data processing and comparison is, preferably, assisted by suitable computer programs and databases. Automation as described herein before allows using the method of the present invention in high-throughput approaches.

Moreover, the at least one biomarker can also be determined by a specific chemical or biological assay. Said assay shall comprise means which allow to specifically detect the at least one biomarker in the sample. Preferably, said means are capable of specifically recognizing the chemical structure of the biomarker or are capable of specifically identifying the biomarker based on its capability to react with other compounds or its capability to elicit a response in a biological read out system (e.g., induction of a reporter gene). Means which are capable of specifically recognizing the chemical structure of a biomarker are, preferably, antibodies or other proteins which specifically interact with chemical structures, such as receptors or enzymes. Specific antibodies, for instance, may be obtained using the biomarker as antigen by methods well known in the art. Antibodies as referred to herein include both polyclonal and monoclonal antibodies, as well as fragments thereof, such as Fv, Fab and F(ab)₂ fragments that are capable of binding the antigen or hapten. The present invention also includes humanized hybrid antibodies wherein amino acid sequences of a non-human donor antibody exhibiting a desired antigen-specificity are combined with sequences of a human acceptor antibody. Moreover, encompassed are single chain antibodies. The donor sequences will usually include at least the antigen-binding amino acid residues of the donor but may comprise other structurally and/or functionally relevant amino acid residues of the donor antibody as well. Such hybrids can be prepared by several methods well known in the art. Suitable proteins which are capable of specifically recognizing the biomarker are, preferably, enzymes which are involved in the metabolic conversion of the said biomarker. Said enzymes may either use the biomarker as a substrate or may convert a substrate into the biomarker. Moreover, said antibodies may be used as a basis to generate oligopeptides which specifically recognize the biomarker. These oligopeptides shall, for example, comprise the enzyme's binding domains or pockets for the said biomarker. Suitable antibody and/or enzyme based assays may be RIA (radioimmunoassay), ELISA (enzyme-linked immunosorbent assay), sandwich enzyme immune tests, electro-chemiluminescence sandwich immunoassays (ECLIA), dissociation-enhanced lanthanide fluoro immuno assay (DELFIA) or solid phase immune tests. Moreover, the biomarker may also be determined based on its capability to react with other compounds, i.e. by a specific chemical reaction. Further, the biomarker may be determined in a sample due to its capability to elicit a response in a biological read out system. The biological response shall be detected as read out indicating the presence and/or the amount of the biomarker comprised by the sample. The biological response may be, e.g., the induction of gene expression or a phenotypic response of a cell or an organism. In a preferred embodiment the determination of the least one biomarker is a quantitative process, e.g., allowing also the determination of the amount of the at least one biomarker in the sample

As described above, said determining of the at least one biomarker can, preferably, comprise mass spectrometry (MS). Mass spectrometry as used herein encompasses all techniques which allow for the determination of the molecular weight (i.e. the mass) or a mass variable corresponding to a compound, i.e. a biomarker, to be determined in accordance with the present invention. Preferably, mass spectrometry as used herein relates to GC-MS, LC-MS, direct infusion mass spectrometry, FT-ICR-MS, CE-MS, HPLC-MS, quadrupole mass spectrometry, any sequentially coupled mass spectrometry such as MS-MS or MS-MS-MS, ICP-MS, Py-MS, TOF or any combined approaches using the aforementioned techniques. How to apply these techniques is well known to the person skilled in the art. Moreover, suitable devices are commercially available. More preferably, mass spectrometry as used herein relates to LC-MS and/or GC-MS, i.e. to mass spectrometry being operatively linked to a prior chromatographic separation step. More preferably, mass spectrometry as used herein encompasses quadrupole MS. Most preferably, said quadrupole MS is carried out as follows: a) selection of a mass/charge quotient (m/z) of an ion created by ionisation in a first analytical quadrupole of the mass spectrometer, b) fragmentation of the ion selected in step a) by applying an acceleration voltage in an additional subsequent quadrupole which is filled with a collision gas and acts as a collision chamber, c) selection of a mass/charge quotient of an ion created by the fragmentation process in step b) in an additional subsequent quadrupole, whereby steps a) to c) of the method are carried out at least once and analysis of the mass/charge quotient of all the ions present in the mixture of substances as a result of the ionisation process, whereby the quadrupole is filled with collision gas but no acceleration voltage is applied during the analysis. Details on said most preferred mass spectrometry to be used in accordance with the present invention can be found in WO 03/073464.

More preferably, said mass spectrometry is liquid chromatography (LC) MS and/or gas chromatography (GC) MS. Liquid chromatography as used herein refers to all techniques which allow for separation of compounds (i.e. metabolites) in liquid or supercritical phase. Liquid chromatography is characterized in that compounds in a mobile phase are passed through the stationary phase. When compounds pass through the stationary phase at different rates they become separated in time since each individual compound has its specific retention time (i.e. the time which is required by the compound to pass through the system). Liquid chromatography as used herein also includes HPLC. Devices for liquid chromatography are commercially available, e.g. from Agilent Technologies, USA. Gas chromatography as applied in accordance with the present invention, in principle, operates comparable to liquid chromatography. However, rather than having the compounds (i.e. metabolites) in a liquid mobile phase which is passed through the stationary phase, the compounds will be present in a gaseous volume. The compounds pass the column which may contain solid support materials as stationary phase or the walls of which may serve as or are coated with the stationary phase. Again, each compound has a specific time which is required for passing through the column. Moreover, in the case of gas chromatography it is preferably envisaged that the compounds are derivatised prior to gas chromatography. Suitable techniques for derivatisation are well known in the art. Preferably, derivatisation in accordance with the present invention relates to methoxymation and trimethylsilylation of, preferably, polar compounds and transmethylation, methoxymation and trimethylsilylation of, preferably, non-polar (i.e. lipophilic) compounds.

The term “reference” refers to values of characteristic features of each of the biomarker which can be correlated to a medical condition, i.e. the presence or absence of the disease, diseases status or an effect referred to herein. Preferably, a reference is a threshold amount for a biomarker whereby amounts found in a sample to be investigated which are higher than or essentially identical to the threshold are indicative for the presence of a medical condition while those being lower are indicative for the absence of the medical condition. It will be understood that also preferably, a reference may be a threshold amount for a biomarker whereby amounts found in a sample to be investigated which are lower or identical than the threshold are indicative for the presence of a medical condition while those being higher are indicative for the absence of the medical condition.

In accordance with the aforementioned method of the present invention, a reference is, preferably, a reference amount obtained from a sample from a subject known to suffer from MS. In such a case, an amount for the at least one biomarker found in the test sample being essentially identical is indicative for the presence of the disease. Moreover, the reference, also preferably, could be from a subject known not to suffer from MS, preferably, an apparently healthy subject. In such a case, an amount for the at least one biomarker found in the test sample being altered with respect to the reference is indicative for the presence of the disease. The same applies mutatis mutandis for a calculated reference, most preferably the average or median, for the relative or absolute amount of the at least one biomarker of a population of individuals comprising the subject to be investigated. The absolute or relative amounts of the at least one biomarker of said individuals of the population can be determined as specified elsewhere herein. How to calculate a suitable reference value, preferably, the average or median, is well known in the art. The population of subjects referred to before shall comprise a plurality of subjects, preferably, at least 5, 10, 50, 100, 1,000 or 10,000 subjects. It is to be understood that the subject to be diagnosed by the method of the present invention and the subjects of the said plurality of subjects are of the same species.

The amounts of the test sample and the reference amounts are essentially identical, if the values for the characteristic features and, in the case of quantitative determination, the intensity values are essentially identical. Essentially identical means that the difference between two amounts is, preferably, not significant and shall be characterized in that the values for the intensity are within at least the interval between 1^{st} and 99^{th} percentile, 5^{th} and 95^{th} percentile, 10^{th} and 90^{th} percentile, 20^{th} and 80^{th} percentile, 30^{th} and 70^{th} percentile, 40^{th} and 60^{th} percentile of the reference value, preferably, the 50^{th}, 60^{th}, 70^{th}, 80^{th}, 90^{th} or 95^{th} percentile of the reference value. Statistical test for determining whether two amounts are essentially identical are well known in the art and are also described elsewhere herein.

An observed difference for two amounts, on the other hand, shall be statistically significant. A difference in the relative or absolute amount is, preferably, significant outside of the interval between 45^{th} and 55^{th} percentile, 40^{th} and 60^{th} percentile, 30^{th} and 70^{th} percentile, 20^{th} and 80^{th} percentile, 10^{th} and 90^{th} percentile, 5^{th} and 95^{th} percentile, 1^{st} and 99^{th} percentile of the reference value. Preferred changes and fold-regulations are described in the accompanying Tables as well as in the Examples.

Preferably, the reference, i.e. values for at least one characteristic features of the at least one biomarker, will be stored in a suitable data storage medium such as a database and are, thus, also available for future assessments.

The term “comparing” refers to determining whether the determined amount of a biomarker is essentially identical to a reference or differs therefrom. Preferably, a biomarker is deemed to differ from a reference if the observed difference is statistically significant which can be determined by statistical techniques referred to elsewhere in this description. If the difference is not statistically significant, the biomarker amount and the reference amount are essentially identical. Based on the comparison referred to above, a subject can be assessed to suffer from the disease, or not.

For the specific biomarkers referred to in this specification, preferred values for the changes in the relative amounts (i.e. “fold”-regulation) or the kind of regulation (i.e. “up”- or “down”-regulation resulting in a higher or lower relative and/or absolute amount) are indicated in the following Tables and in the Examples below. If it is indicated in said table that a given biomarker is “up-regulated” in a subject, the relative and/or absolute amount will be increased, if it is “down-regulated”, the relative and/or absolute amount of the biomarker will be decreased. Moreover, the “fold”-change indicates the degree of increase or decrease, e.g., a 2-fold increase means that the median of one group, e.g., the MS group, is twice the median of the biomarker of the other group, e.g., the control group.

The comparison is, preferably, assisted by automation. For example, a suitable computer program comprising algorithms for the comparison of two different data sets (e.g., data sets comprising the values of the characteristic feature(s)) may be used. Such computer programs and algorithm are well known in the art. Notwithstanding the above, a comparison can also be carried out manually.

Advantageously, it has been found in the study underlying the present invention that the amounts of the specific biomarkers referred to above are indicators for MS. Accordingly, the at least one biomarker as specified above in a sample can, in principle, be used for assessing whether a subject suffers from MS. This is particularly helpful for an efficient diagnosis of the disease as well as for improving of the pre-clinical and clinical management of MS as well as an efficient monitoring of patients. Moreover, the findings underlying the present invention will also facilitate the development of efficient drug-based therapies against MS as set forth in detail below. The definitions and explanations of the terms made above apply mutatis mutandis for the following embodiments of the present invention except specified otherwise herein below.

The present invention also relates to a method for identifying whether a subject is in need for a therapy of multiple sclerosis comprising the steps of the aforementioned method of diagnosing MS and the further step of identifying a subject in need if multiple sclerosis is diagnosed.

The phrase “in need for a therapy of multiple sclerosis” as used herein means that the disease in the subject is in a status where therapeutic intervention is necessary or beneficial in order to ameliorate or treat MS or the symptoms associated therewith. Accordingly, the findings of the studies underlying the present invention do not only allow diagnosing MS in a subject but also allow for identifying subjects which should be treated by an MS therapy. Once the subject has been identified, the method may further include a step of making recommendations for a therapy of MS.

A therapy of multiple sclerosis as used in accordance with the present invention, preferably, relates to a therapy which comprises or consists of the administration of at least one drug selected from the group consisting of: Interferon Beta1a, Interferon Beta 1b, Azathioprin, Cyclophosphamide, Glatiramer Acetate, Immunglobuline, Methotrexat, Mitoxantrone, Leustatin, IVIg, Natalizumab, Teriflunomid, Statins, Daclizumab, Alemtuzumab, Ritximab, Sphingosin 1 phosphate antagonist Fingolimod (FTY720), Cladribine, Fumarate, Laquinimod, drugs affecting B-cells, and antisense agents against CD49d.

Moreover, the present invention contemplates a method for determining whether a multiple sclerosis therapy is successful comprising the steps of:
a) determining at least one biomarker selected from the biomarkers listed in Table 1, 2, 3 and/or 4 in a first and a second sample of the subject wherein said first sample has been taken prior to or at the onset of the multiple sclerosis therapy and said second sample has been taken after the onset of the said therapy; and
b) comparing the amount of the said at least one biomarker in the first sample to the amount in the second sample, whereby a change in the amount determined in the second sample in comparison to the first sample is indicative for multiple sclerosis therapy being successful.

It is to be understood that an MS therapy will be successful if MS or at least some symptoms thereof can be treated or ameliorated compared to an untreated subject. This can be investigated, preferably, by the biomarkers listed in Table 1 and/or 2. Moreover, a therapy is also successful as meant herein if the disease progression can be prevented or at least slowed down compared to an untreated subject. This can also be investigated, preferably, by the biomarkers listed in Table 1 and/or 2. Moreover, since disease progression is also related with a more frequent occurrence of the active status, it can also be assessed by biomarkers set forth in Table 3 and/or 4.

In a preferred embodiment of the aforementioned method, said change is a decrease and wherein said at least one biomarker is selected from the biomarkers listed in Table 1a and/or 2a.

In yet another preferred embodiment of the method of the present invention, said change is an increase and wherein said at least one biomarker is selected from the biomarkers listed in Table 1b and/or 2b.

The present invention, further, relates to a method for diagnosing an active status of multiple sclerosis in a subject comprising the steps of:
a) determining in a sample of the subject the amount of at least one biomarker selected from the biomarkers listed in Table 3 and/or Table 4; and
b) comparing the amount of the said at least one biomarker to a reference amount, whereby multiple sclerosis is to be diagnosed.

For the present method, it will be understood that the reference amount is, preferably, derived from a subject exhibiting a stable status of MS. The said reference amount can be obtained from any subject known to exhibit a stable status of the disease. This also includes that the reference amount was derived from an earlier sample of the subject to be diagnosed wherein said earlier sample has been obtained at a phase where the subject exhibited a stable status.

In a preferred embodiment of the aforementioned method, said at least one biomarker is selected from the group of biomarkers listed in Table 3a and wherein an increase in the said at least one biomarker is indicative for an active status of MS.

In another preferred embodiment of the aforementioned method, said at least one biomarker is selected from the group of biomarkers listed in Table 3b and/or Table 4 and wherein a decrease in the said at least one biomarker is indicative for an active status of

MS.

The present invention also relates to a method for predicting whether a subject is at risk of developing multiple sclerosis comprising the steps of:
a) determining in a sample of the subject the amount of at least one biomarker selected from the biomarkers listed in Table 1 and/or 2; and
b) comparing the amount of the said at least one biomarker to a reference amount, whereby it is predicted whether a subject is at risk of developing multiple sclerosis.

The term “predicting” as used herein, in general, refers to determining the probability according to which a subject will develop a medical condition or its accompanying symptoms within a certain time window after the sample has been taken (i.e. the predictive window). It will be understood that such a prediction will not necessarily be correct for all (100%) of the investigated subjects. However, it is envisaged that the prediction will be correct for a statistically significant portion of subjects of a population of subjects (e.g., the subjects of a cohort study). Whether a portion is statistically significant can be determined by statistical techniques set forth elsewhere herein.

In a preferred embodiment of the aforementioned method for predicting whether a subject is at risk of developing multiple sclerosis, the method is repeated with one or more further samples of the subject which have been taken after the above mentioned (first) sample was taken. Accordingly, by repeating the prediction several times after the initial prediction was made, the prediction power of the method can be further increased.

A method for predicting whether a subject is at risk of developing an active status of multiple sclerosis is also envisaged by the present invention. Said method shall comprise the steps of:
a) determining in a sample of the subject the amount of at least one biomarker selected from the biomarkers listed in Table 3 and/or 4; and
b) comparing the amount of the said at least one biomarker to a reference amount, whereby it is predicted whether a subject is at risk of developing an active status of multiple sclerosis.

Furthermore, the present invention relates to a method for identifying whether a subject is in need for a therapy against the active status of multiple sclerosis comprising the steps of the aforementioned method for predicting whether a subject is at risk of developing an active status of multiple sclerosis and the further steps of identifying a subject in need if the subject is predicted to be at risk of developing an active status of multiple sclerosis.

The aforementioned methods for the determination of the at least one biomarker can be implemented into a device. A device as used herein shall comprise at least the aforementioned means. Moreover, the device, preferably, further comprises means for comparison and evaluation of the detected characteristic feature(s) of the at least one biomarker and, also preferably, the determined signal intensity. The means of the device are, preferably, operatively linked to each other. How to link the means in an operating manner will depend on the type of means included into the device. For example, where means for automatically qualitatively or quantitatively determining the biomarker are applied, the data obtained by said automatically operating means can be processed by, e.g., a computer program in order to facilitate the assessment. Preferably, the means are comprised by a single device in such a case. Said device may accordingly include an analyzing unit for the biomarker and a computer unit for processing the resulting data for the assessment. Preferred devices are those which can be applied without the particular knowledge of a specialized clinician, e.g., electronic devices which merely require loading with a sample.

Alternatively, the methods for the determination of the at least one biomarker can be implemented into a system comprising several devices which are, preferably, operatively linked to each other. Specifically, the means must be linked in a manner as to allow carrying out the method of the present invention as described in detail above. Therefore, operatively linked, as used herein, preferably, means functionally linked. Depending on the means to be used for the system of the present invention, said means may be functionally linked by connecting each mean with the other by means which allow data transport in between said means, e.g., glass fiber cables, and other cables for high throughput data transport. Nevertheless, wireless data transfer between the means is also envisaged by the present invention, e.g., via LAN (Wireless LAN, W-LAN). A preferred system comprises means for determining biomarkers. Means for determining biomarkers as used herein encompass means for separating biomarkers, such as chromatographic devices, and means for metabolite determination, such as mass spectrometry devices. Suitable devices have been described in detail above. Preferred means for compound separation to be used in the system of the present invention include chromatographic devices, more preferably devices for liquid chromatography, HPLC, and/or gas chromatography. Preferred devices for compound determination comprise mass spectrometry devices, more preferably, GC-MS, LC-MS, direct infusion mass spectrometry, FT-ICR-MS, CE-MS, HPLC-MS, quadrupole mass spectrometry, sequentially coupled mass spectrometry (including MS-MS or MS-MS-MS), ICP-MS, Py-MS or TOF. The separation and determination means are, preferably, coupled to each other. Most preferably, LC-MS and/or GC-MS are used in the system of the present invention as described in detail elsewhere in the specification. Further comprised shall be means for comparing and/or analyzing the results obtained from the means for determination of biomarkers. The means for comparing and/or analyzing the results may comprise at least one databases and an implemented computer program for comparison of the results. Preferred embodiments of the aforementioned systems and devices are also described in detail below.

Therefore, the present invention relates to a diagnostic device comprising:
a) an analysing unit comprising a detector for at least one biomarker as listed in any one of Tables 1, 1a, 1b, 2, 2a, 2b, 3, 3a, 3b or 4 wherein said analyzing unit is adapted for determining the amount of the said biomarker detected by the detector, and, operatively linked thereto;
b) an evaluation unit comprising a computer comprising tangibly embedded a computer program code for carrying out a comparison of the determined amount of the at least one biomarker and a reference amount and a data base comprising said reference amount as for the said biomarker whereby a multiple sclerosis in a subject, a subject is in need for a therapy of multiple sclerosis or the success of a multiple sclerosis is identified if the result of the comparison for the at least one metabolite is essentially identical to the kind of regulation and/or fold of regulation indicated for the respective at least one biomarker in any one of Tables 1, 1a, 1b, 2, 2a, 2b, 3, 3a, 3b or 4.

In a preferred embodiment, the device comprises a further database comprising the kind of regulation and/or fold of regulation values indicated for the respective at least one biomarker in any one of Tables 1, 1a, 1b, 2, 2a, 2b, 3, 3a, 3b or 4 and a further tangibly embedded computer program code for carrying out a comparison between the determined kind of regulation and/or fold of regulation values and those comprised by the database.

Furthermore, the present invention relates to a data collection comprising characteristic values of at least one biomarker being indicative for a medical condition or effect as set forth above (i.e. diagnosing multiple sclerosis in a subject, identifying whether a subject is in need for a therapy of multiple sclerosis or determining whether a multiple sclerosis therapy is successful).

The term “data collection” refers to a collection of data which may be physically and/or logically grouped together. Accordingly, the data collection may be implemented in a single data storage medium or in physically separated data storage media being operatively linked to each other. Preferably, the data collection is implemented by means of a database. Thus, a database as used herein comprises the data collection on a suitable storage medium. Moreover, the database, preferably, further comprises a database management system. The database management system is, preferably, a network-based, hierarchical or object-oriented database management system. Furthermore, the database may be a federal or integrated database. More preferably, the database will be implemented as a distributed (federal) system, e.g. as a Client-Server-System. More preferably, the database is structured as to allow a search algorithm to compare a test data set with the data sets comprised by the data collection. Specifically, by using such an algorithm, the database can be searched for similar or identical data sets being indicative for a medical condition or effect as set forth above (e.g. a query search). Thus, if an identical or similar data set can be identified in the data collection, the test data set will be associated with the said medical condition or effect. Consequently, the information obtained from the data collection can be used, e.g., as a reference for the methods of the present invention described above. More preferably, the data collection comprises characteristic values of all metabolites comprised by any one of the groups recited above.

In light of the foregoing, the present invention encompasses a data storage medium comprising the aforementioned data collection.

The term “data storage medium” as used herein encompasses data storage media which are based on single physical entities such as a CD, a CD-ROM, a hard disk, optical storage media, or a diskette. Moreover, the term further includes data storage media consisting of physically separated entities which are operatively linked to each other in a manner as to provide the aforementioned data collection, preferably, in a suitable way for a query search.

The present invention also relates to a system comprising:
(a) means for comparing characteristic values of the at least one biomarker of a sample operatively linked to
(b) a data storage medium as described above.

The term “system” as used herein relates to different means which are operatively linked to each other. Said means may be implemented in a single device or may be physically separated devices which are operatively linked to each other. The means for comparing characteristic values of biomarkers, preferably, based on an algorithm for comparison as mentioned before. The data storage medium, preferably, comprises the aforementioned data collection or database, wherein each of the stored data sets being indicative for a medical condition or effect referred to above. Thus, the system of the present invention allows identifying whether a test data set is comprised by the data collection stored in the data storage medium. Consequently, the methods of the present invention can be implemented by the system of the present invention.

In a preferred embodiment of the system, means for determining characteristic values of biomarkers of a sample are comprised. The term “means for determining characteristic values of biomarkers” preferably relates to the aforementioned devices for the determination of metabolites such as mass spectrometry devices, NMR devices or devices for carrying out chemical or biological assays for the biomarkers.

Moreover, the present invention relates to a diagnostic means comprising means for the determination of at least one biomarker selected from any one of the groups referred to above.

The term “diagnostic means”, preferably, relates to a diagnostic device, system or biological or chemical assay as specified elsewhere in the description in detail.

The expression “means for the determination of at least one biomarker” refers to devices or agents which are capable of specifically recognizing the biomarker. Suitable devices may be spectrometric devices such as mass spectrometry, NMR devices or devices for carrying out chemical or biological assays for the biomarkers. Suitable agents may be compounds which specifically detect the biomarkers. Detection as used herein may be a two-step process, i.e. the compound may first bind specifically to the biomarker to be detected and subsequently generate a detectable signal, e.g., fluorescent signals, chemiluminescent signals, radioactive signals and the like. For the generation of the detectable signal further compounds may be required which are all comprised by the term “means for determination of the at least one biomarker”. Compounds which specifically bind to the biomarker are described elsewhere in the specification in detail and include, preferably, enzymes, antibodies, ligands, receptors or other biological molecules or chemicals which specifically bind to the biomarkers.

Further, the present invention relates to a diagnostic composition comprising at least one biomarker selected from any one of the groups referred to above.

The at least one biomarker selected from any of the aforementioned groups will serve as a biomarker, i.e. an indicator molecule for a medical condition or effect in the subject as set for the elsewhere herein. Thus, the metabolite molecules itself may serve as diagnostic compositions, preferably, upon visualization or detection by the means referred to in herein. Thus, a diagnostic composition which indicates the presence of a biomarker according to the present invention may also comprise the said biomarker physically, e.g., a complex of an antibody and the metabolite to be detected may serve as the diagnostic composition. Accordingly, the diagnostic composition may further comprise means for detection of the metabolites as specified elsewhere in this description. Alternatively, if detection means such as MS or NMR based techniques are used, the molecular species which serves as an indicator for the risk condition will be the at least one biomarker comprised by the test sample to be investigated. Thus, the at least one biomarker referred to in accordance with the present invention shall serve itself as a diagnostic composition due to its identification as a biomarker.

In general, the present invention contemplates the use of at least one biomarker selected from the biomarkers selected in any one of Tables 1, 2, 1a, 2a or 1b, 2b in a sample of a subject for diagnosing multiple sclerosis, the use of at least one biomarker selected from the biomarkers selected in any one of Tables 3, 4, 3a; 4a or 3b; 4b in a sample of a subject for diagnosing an active status of multiple sclerosis, or the use of at least one biomarker selected from the biomarkers of Table 1 and/or 2 in a sample of a subject for predicting multiple sclerosis as well as the use of at least one biomarker selected from the biomarkers of Table 3 and/4 in a sample of a subject for predicting an active status of multiple sclerosis.

All references cited herein are herewith incorporated by reference with respect to their disclosure content in general or with respect to the specific disclosure contents indicated above.

The invention will now be illustrated by the following Examples which are not intended to restrict or limit the scope of this invention.

### EXAMPLE 1

### Determination of Metabolites

Human serum samples were prepared and subjected to LC-MS/MS and GC-MS.

The samples were prepared in the following way: Proteins were separated by precipitation from blood serum. After addition of water and a mixture of ethanol and dichlormethan the remaining sample was fractioned into an aqueous, polar phase (polar fraction) and an organic, lipophilic phase (lipid fraction).

For the transmethanolysis of the lipid extracts a mixture of 140 μl of chloroform, 37 μl of hydrochloric acid (37% by weight HCl in water), 320 μl of methanol and 20 μl of toluene was added to the evaporated extract. The vessel was sealed tightly and heated for 2 hours at 100° C., with shaking. The solution was subsequently evaporated to dryness. The residue was dried completely.

The methoximation of the carbonyl groups was carried out by reaction with methoxyamine hydrochloride (20 mg/ml in pyridine, 100 μl for 1.5 hours at 60° C.) in a tightly sealed vessel. 20 μl of a solution of odd-numbered, straight-chain fatty acids (solution of each 0.3 mg/mL of fatty acids from 7 to 25 carbon atoms and each 0.6 mg/mL of fatty acids with 27, 29 and 31 carbon atoms in 3/7 (v/v) pyridine/toluene) were added as time standards. Finally, the derivatization with 100 μl of N-methyl-N-(trimethylsilyl)-2,2,2-trifluoroacetamide (MSTFA) was carried out for 30 minutes at 60° C., again in the tightly sealed vessel. The final volume before injection into the GC was 220 μl.

For the polar phase the derivatization was performed in the following way: The methoximation of the carbonyl groups was carried out by reaction with methoxyamine hydrochloride (20 mg/ml in pyridine, 50 μl for 1.5 hours at 60° C.) in a tightly sealed vessel. 10 μl of a solution of odd-numbered, straight-chain fatty acids (solution of each 0.3 mg/mL of fatty acids from 7 to 25 carbon atoms and each 0.6 mg/mL of fatty acids with 27, 29 and 31 carbon atoms in 3/7 (v/v) pyridine/toluene) were added as time standards. Finally, the derivatization with 50 μl of N-methyl-N-(trimethylsilyl)-2,2,2-trifluoroacetamide (MSTFA) was carried out for 30 minutes at 60° C., again in the tightly sealed vessel. The final volume before injection into the GC was 110 μl.

The GC-MS systems consist of an Agilent 6890 GC coupled to an Agilent 5973 MSD. The autosamplers are CompiPal or GCPal from CTC.

For the analysis usual commercial capillary separation columns (30 m×0.25 mm×0.25 μm) with different poly-methyl-siloxane stationary phases containing 0% up to 35% of aromatic moieties, depending on the analysed sample materials and fractions from the phase separation step, were used (for example: DB-1ms, HP-5ms, DB-XLB, DB-35ms, Agilent Technologies). Up to 1 μL of the final volume was injected splitless and the oven temperature program was started at 70° C. and ended at 340° C. with different heating rates depending on the sample material and fraction from the phase separation step in order to achieve a sufficient chromatographic separation and number of scans within each analyte peak. Furthermore RTL (Retention Time Locking, Agilent Technologies) was used for the analysis and usual GC-MS standard conditions, for example constant flow with nominal 1 to 1.7 ml/min. and helium as the mobile phase gas, ionisation was done by electron impact with 70 eV, scanning within a m/z range from 15 to 600 with scan rates from 2.5 to 3 scans/sec and standard tune conditions.

The HPLC-MS systems consisted of an Agilent 1100 LC system (Agilent Technologies, Waldbronn, Germany) coupled with an API 4000 Mass spectrometer (Applied Biosystem/MDS SCIEX, Toronto, Canada). HPLC analysis was performed on commercially available reversed phase separation columns with C18 stationary phases (for example: GROM ODS 7 pH, Thermo Betasil C18). Up to 10 μL of the final sample volume of evaporated and reconstituted polar and lipophilic phase was injected and separation was performed with gradient elution using methanol/water/formic acid or acetonitrile/water/formic acid gradients at a flowrate of 200 μL/min.

Mass spectrometry was carried out by electrospray ionisation in positive mode for the non-polar fraction (lipid fraction) and negative mode for the polar fraction using multiple-reaction-monitoring-(MRM)-mode and fullscan from 100-1000 amu.

Steroids and their metabolites were measured by online SPE-LC-MS (Solid phase extraction-LC-MS). Catecholamines and their metabolites were measured by online SPE-LC-MS as described by Yamada et al. (Yamada 2002, Journal of Analytical Toxicology, 26(1): 17-22))

Analysis of Complex Lipids in Serum Samples:

Total lipids were extracted from serum by liquid/liquid extraction using chloroform/methanol.

The lipid extracts were subsequently fractionated by normal phase liquid chromatography (NPLC) into eleven different lipid groups according to Christie 1985, (Journal of Lipid Research (26), 507-512)).

The lipid classes of Free fatty acids (FFA), Diacylglycerides (DAG), Triacylglycerides (TAG), Phosphatidylinositols (PI), Phosphatidylethanolamines (PE), Phosphatidylcholines (PC), Lysophosphatidylcholines (LPC), Free sterols (FS), Phosphatidylserines (PS) were measured by GC.

The fractions were analyzed by GC-MS after derivatization with TMSH (Trimethyl sulfonium hydroxide), yielding the fatty acid methyl esters (FAME) corresponding to the acyl moieties of the class-separated lipids. The concentrations of FAME from C14 to C24 were determined in each fraction.

The lipid classes Cholesteryesters (CE) and Sphingomyelins (SM) were analyzed by LC-MS/MS using electrospray ionization (ESI) and atmospheric pressure chemical ionization (APCI) with detection of specific multiple reaction monitoring (MRM) transitions for cholesterylesters and sphingoymelins, respectively.

### EXAMPLE 2

### Data Analysis

Serum samples were analyzed in randomized analytical sequence design with pooled samples (so called “Pool”) generated from aliquots of each sample. The raw peak data were normalized to the median of pool per analytical sequence to account for process variability (so called “ratios”).

Following comprehensive analytical validation steps, the data for each analyte were normalized against data from pool samples. These samples were run in parallel through the whole process to account for process variability.

Serum samples from 70 patients suffering from multiple sclerosis and 59 healthy controls were analyzed. Of the 70 patients, 43 were in a stable phase of multiple sclerosis, while 27 patients were suffering from active lesions. Additional clinical information for all subjects (e.g. gender, age, BMI, date of sampling, disease status, medication, EDSS (Expanded Disability Status Score) and therapy) were partly included in the analysis.

Groups were compared by Welch test (two-sided t-test assuming unequal variance) and p-values of Welch test indicating statistical significance. Ratios of median metabolite levels per group were derived indicating effect size. Regulation type was determined for each metabolite as “up” for increased (ratios >1, also called “fold” reference) within the respective group vs. reference and “down” for decreased (ratios <1, also called “fold” reference) vs. reference.

The results of the analyses are summarized in the following tables, below.

1.

TABLE 1
Biomarkers which are significantly altered between
MS patients and healthy individuals

| | | Median | |
|---|---|---|---|
| | Kind of | of MS | |
| | regulation | patients | |
| | (“up” or | relative | p-value |
| Metabolite | “down”) | to controls | of t-test |
| Glycerate | up | 2.359 | 7.30E−37 |
| Erythronic acid | up | 1.459 | 2.50E−13 |
| erythro-C16-Sphingosine (*1) | down | 0.897 | 4.50E−02 |
| 1,5-Anhydrosorbitol | down | 0.82 | 1.80E−02 |
| myo-Inositol-2-phosphate | down | 0.877 | 2.10E−04 |
| Indole-3-lactic acid | down | 0.849 | 1.80E−06 |
| Ketoleucine | down | 0.871 | 1.50E−05 |
| Tricosanoic acid (C23:0) | down | 0.827 | 3.60E−04 |
| Prostaglandin F2 alpha | up | 1.572 | 1.10E−02 |
| trans-4-Hydroxyproline | up | 1.199 | 3.10E−04 |
| Pseudouridine | up | 1.07 | 5.70E−03 |
| 3-Hydroxyisobutyrate | down | 0.835 | 5.60E−03 |
| Ceramide (d18:1, C24:1) | up | 1.287 | 1.30E−06 |
| Ceramide (d18:1, C24:0) | up | 1.205 | 5.40E−05 |
| Phosphatidylcholine (C18:0, C18:1) | down | 0.983 | 3.50E−02 |
| Phosphatidylcholine (C16:1, C18:2) | down | 0.868 | 1.80E−02 |
| TAG (C18:1, C18:2) (*2) | up | 1.11 | 2.70E−02 |
| DAG (C18:1, C18:2) | up | 1.195 | 1.70E−03 |
| Lysophosphatidylcholine (C16:0) | down | 0.993 | 1.80E−02 |
| Lysophosphatidylcholine (C17:0) | up | 1.095 | 1.40E−02 |
| Free cholesterol | up | 1.116 | 1.10E−02 |
| 5-Hydroxyeicosatetraenoic acid | up | 3.489 | 7.30E−16 |
| (C20:trans[6]cis[8,11,14]4) (5-HETE) | | | |
| 8,9-Dihydroxyeicosatrienoic acid | up | 1.859 | 6.60E−12 |
| (C20:cis[5,11,14]3) | | | |
| 8-Hydroxyeicosatetraenoic acid | up | 5.152 | 4.70E−11 |
| (C20:trans[5]cis[9,11,14]4) (8-HETE) | | | |
| 15-Hydroxyeicosatetraenoic acid | up | 3.214 | 1.10E−07 |
| (C20:cis[5,8,11,13]4) | | | |
| 11,12-Dihydroxyeicosatrienoic acid | up | 1.256 | 1.00E−03 |
| (C20:cis[5,8,14]3) | | | |
| 11-Hydroxyeicosatetraenoic acid | up | 2.439 | 1.30E−03 |
| (C20:cis[5,8,12,14]4) | | | |
| 14,15-Dihydroxyeicosatrienoic acid | up | 1.325 | 2.60E−03 |
| (C20:cis[5,8,11]3) | | | |
| Cystine | down | 0.687 | 2.80E−08 |
| Lactate | up | 1.581 | 6.20E−08 |
| Ornithine | up | 1.407 | 1.90E−06 |
| Cysteine | down | 0.866 | 6.70E−06 |
| Eicosatrienoic acid | down | 0.91 | 1.60E−02 |
| (C20:cis[8,11,14]3) | | | |
| Malate | up | 1.241 | 6.00E−04 |
| Mannose | up | 1.23 | 7.30E−04 |
| beta-Alanine | up | 1.014 | 1.00E−02 |
| Glucose | down | 0.921 | 1.00E−02 |
| Mannosamine | down | 0.841 | 1.10E−02 |
| Glycerol, polar fraction | up | 1.095 | 4.80E−02 |
| Dodecanol | up | 2.107 | 2.00E−24 |
| Glutamate | up | 2.868 | 6.40E−20 |
| Xanthine | up | 1.485 | 3.90E−12 |
| Aspartate | up | 1.633 | 1.10E−09 |
| Phosphate (inorganic and | down | 0.808 | 5.00E−09 |
| from organic phosphates) | | | |
| Taurine | up | 1.533 | 2.10E−08 |
| Glycine | up | 1.287 | 9.20E−07 |
| Tryptophan | down | 0.867 | 2.50E−06 |
| 3,4-Dihydroxyphenylacetic acid | down | 0.725 | 3.50E−06 |
| (DOPAC) | | | |
| Serotonin (5-HT) | down | 0.734 | 8.20E−06 |
| Serine | up | 1.228 | 2.80E−05 |
| 3,4-Dihydroxyphenylglycol | down | 0.858 | 5.00E−05 |
| (DOPEG) | | | |
| alpha-Tocopherol | up | 1.114 | 7.90E−05 |
| Maltose | up | 1.624 | 9.50E−05 |
| Corticosterone | up | 1.496 | 2.50E−04 |
| Hypoxanthine | up | 1.174 | 7.40E−04 |
| Methionine | down | 0.908 | 1.10E−03 |
| Epinephrine | down | 0.605 | 2.40E−03 |
| 11-Deoxycortisol | up | 1.44 | 4.10E−03 |
| Glucosamine | down | 0.818 | 4.40E−03 |
| Glycerol phosphate, lipid fraction | down | 0.863 | 6.40E−03 |
| Phosphate, lipid fraction | down | 0.922 | 1.30E−02 |
| Leucine | down | 0.934 | 2.20E−02 |
| Histidine | down | 0.937 | 2.50E−02 |
| Valine | down | 0.969 | 2.50E−02 |
| Dopamine | up | 1.384 | 3.00E−02 |
| Threonine | down | 0.962 | 4.90E−02 |
| Glutamine - (MetID 38300144) | down | 0.873 | 5.90E−04 |
| Docosapentaenoic acid | down | 0.861 | 3.30E−03 |
| (C22:cis[4,7,10,13,16]5) - | | | |
| (MetID 28300490) | | | |
| Sphingomyelin (d18:1, C23:0) - | down | 0.898 | 3.60E−03 |
| (MetID 68300022) | | | |
| TAG (C16:0, C18:1, C18:3) - | up | 1.146 | 1.90E−02 |
| (MetID 68300057) | | | |
| TAG (C16:0, C18:1, C18:2) - | up | 1.147 | 2.40E−02 |
| (MetID 68300031) | | | |
| Lysophosphatidylethanolamine | up | 1.089 | 3.30E−02 |
| (C22:5) - (MetID 68300002) | | | |
| Sphingomyelin (d18:2, C18:0) - | up | 1.064 | 4.50E−02 |
| (MetID 68300009) | | | |

(*1: free and from sphingolipids; *2: see Table 5)

TABLE 1a
Biomarkers which are significantly increased in MS patients compared
to healthy individuals

| | | Median | |
|---|---|---|---|
| | | of MS | |
| | | patients | |
| | Kind of | relative | |
| | regulation- | to | p-value |
| Metabolite | up | controls | of t-test |
| Glycerate | up | 2.359 | 7.30E−37 |
| Erythronic acid | up | 1.459 | 2.50E−13 |
| Prostaglandin F2 alpha | up | 1.572 | 1.10E−02 |
| trans-4-Hydroxyproline | up | 1.199 | 3.10E−04 |
| Pseudouridine | up | 1.07 | 5.70E−03 |
| Ceramide (d18:1, C24:1) | up | 1.287 | 1.30E−06 |
| Ceramide (d18:1, C24:0) | up | 1.205 | 5.40E−05 |
| TAG (C18:1, C18:2) (*2) | up | 1.11 | 2.70E−02 |
| DAG (C18:1, C18:2) | up | 1.195 | 1.70E−03 |
| Free cholesterol | up | 1.116 | 1.10E−02 |
| 5-Hydroxyeicosatetraenoic acid | up | 3.489 | 7.30E−16 |
| (C20:trans[6]cis[8,11,14]4) (5-HETE) | | | |
| 8,9-Dihydroxyeicosatrienoic acid | up | 1.859 | 6.60E−12 |
| (C20:cis[5,11,14]3) | | | |
| 8-Hydroxyeicosatetraenoic acid | up | 5.152 | 4.70E−11 |
| (C20:trans[5]cis[9,11,14]4) (8-HETE) | | | |
| 15-Hydroxyeicosatetraenoic acid | up | 3.214 | 1.10E−07 |
| (C20:cis[5,8,11,13]4) | | | |
| 11,12-Dihydroxyeicosatrienoic acid | up | 1.256 | 1.00E−03 |
| (C20:cis[5,8,14]3) | | | |
| 11-Hydroxyeicosatetraenoic acid | up | 2.439 | 1.30E−03 |
| (C20:cis[5,8,12,14]4) | | | |
| 14,15-Dihydroxyeicosatrienoic acid | up | 1.325 | 2.60E−03 |
| (C20:cis[5,8,11]3) | | | |
| Lactate | up | 1.581 | 6.20E−08 |
| Ornithine | up | 1.407 | 1.90E−06 |
| Malate | up | 1.241 | 6.00E−04 |
| Mannose | up | 1.23 | 7.30E−04 |
| beta-Alanine | up | 1.014 | 1.00E−02 |
| Glycerol, polar fraction | up | 1.095 | 4.80E−02 |
| Dodecanol | up | 2.107 | 2.00E−24 |
| Glutamate | up | 2.868 | 6.40E−20 |
| Xanthine | up | 1.485 | 3.90E−12 |
| Aspartate | up | 1.633 | 1.10E−09 |
| Taurine | up | 1.533 | 2.10E−08 |
| Glycine | up | 1.287 | 9.20E−07 |
| Serine | up | 1.228 | 2.80E−05 |
| alpha-Tocopherol | up | 1.114 | 7.90E−05 |
| Maltose | up | 1.624 | 9.50E−05 |
| Corticosterone | up | 1.496 | 2.50E−04 |
| Hypoxanthine | up | 1.174 | 7.40E−04 |
| 11-Deoxycortisol | up | 1.44 | 4.10E−03 |
| Dopamine | up | 1.384 | 3.00E−02 |
| TAG (C16:0, C18:1, C18:3) - | up | 1.146 | 1.90E−02 |
| MetID 68300057 | | | |
| TAG (C16:0, C18:1, C18:2) - | up | 1.147 | 2.40E−02 |
| MetID 68300031 | | | |
| Lysophosphatidylethanolamine | up | 1.089 | 3.30E−02 |
| (C22:5 ) - MetID 68300002 | | | |
| Sphingomyelin (d18:2, C18:0) - | up | 1.064 | 4.50E−02 |
| MetID 68300009 | | | |

(*2) see Table 5)

TABLE 1b
Biomarkers which are significantly decreased in MS patients compared to
healthy individuals

| | | Median | |
|---|---|---|---|
| | | of MS | |
| | | patients | |
| | Kind of | relative | |
| | regulation- | to | p-value |
| Metabolite | down | controls | of t-test |
| erythro-C16-Sphingosine (*1) | down | 0.897 | 4.50E−02 |
| 1,5-Anhydrosorbitol | down | 0.82 | 1.80E−02 |
| myo-Inositol-2-phosphate | down | 0.877 | 2.10E−04 |
| Indole-3-lactic acid | down | 0.849 | 1.80E−06 |
| Ketoleucine | down | 0.871 | 1.50E−05 |
| Tricosanoic acid (C23:0) | down | 0.827 | 3.60E−04 |
| Phosphatidylcholine (C18:0, C18:1) | down | 0.983 | 3.50E−02 |
| Phosphatidylcholine (C16:1, C18:2) | down | 0.868 | 1.80E−02 |
| Lysophosphatidylcholine (C16:0) | down | 0.993 | 1.80E−02 |
| Cystine | down | 0.687 | 2.80E−08 |
| 3-Hydroxyisobutyrate | down | 0.835 | 5.60E−03 |
| Cysteine | down | 0.866 | 6.70E−06 |
| Eicosatrienoic acid (C20:cis[8,11,14]3) | down | 0.91 | 1.60E−02 |
| Isoleucine | down | 0.885 | 3.10E−03 |
| Glucose | down | 0.921 | 1.00E−02 |
| Mannosamine | down | 0.841 | 1.10E−02 |
| Phosphate (inorganic and from organic | down | 0.808 | 5.00E−09 |
| phosphates) | | | |
| Tryptophan | down | 0.867 | 2.50E−06 |
| 3,4-Dihydroxyphenylacetic acid | down | 0.725 | 3.50E−06 |
| (DOPAC) | | | |
| Serotonin (5-HT) | down | 0.734 | 8.20E−06 |
| 3,4-Dihydroxyphenylglycol (DOPEG) | down | 0.858 | 5.00E−05 |
| Methionine | down | 0.908 | 1.10E−03 |
| Epinephrine | down | 0.605 | 2.40E−03 |
| Glucosamine | down | 0.818 | 4.40E−03 |
| Glycerol phosphate, lipid fraction | down | 0.863 | 6.40E−03 |
| Phosphate, lipid fraction | down | 0.922 | 1.30E−02 |
| Leucine | down | 0.934 | 2.20E−02 |
| Histidine | down | 0.937 | 2.50E−02 |
| Valine | down | 0.969 | 2.50E−02 |
| Threonine | down | 0.962 | 4.90E−02 |
| Glutamine - (MetID 38300144) | down | 0.873 | 5.90E−04 |
| Docosapentaenoic acid | down | 0.861 | 3.30E−03 |
| (C22:cis[4,7,10,13,16]5) - | | | |
| (MetID 28300490) | | | |
| Sphingomyelin (d18:1, C23:0) - | down | 0.898 | 3.60E−03 |
| (MetID 68300022) | | | |

(*1) free and from sphingolipids)

TABLE 2
Biomarkers from lipid analysis which are altered between MS patients and
healthy individuals

| | Kind of | Median of | |
|---|---|---|---|
| | regulation | MS | |
| | (eg “up” | patients | |
| | or | relative | p-value |
| Metabolite | “down”) | to controls | of t-test |
| CE_Cholesterylester C18:0 | up | 1.210 | 4.0E−03 |
| CE_Cholesterylester C22:0 | up | 1.050 | 5.7E−03 |
| CE_Cholesterylester C24:6 | down | 0.825 | 3.1E−03 |
| FFA_Palmitic acid (C16:0) | up | 1.385 | 8.5E−04 |
| FFA_Stearic acid (C18:0) | up | 1.248 | 5.2E−03 |
| FFA_Oleic acid (C18:cis[9]1) | up | 1.742 | 2.0E−04 |
| FFA_Linoleic acid (C18:cis[9,12]2) | up | 1.219 | 4.4E−04 |
| LPC_Palmitic acid (C16:0) | up | 1.065 | 2.7E−03 |
| LPC_Stearic acid (C18:0) | up | 1.221 | 5.8E−04 |
| PC_Myristic acid (C14:0) | down | 0.914 | 1.3E−02 |
| PC_Palmitic acid (C16:0) | down | 0.902 | 6.0E−03 |
| PC_Oleic acid (C18:cis[9]1) | down | 0.837 | 4.4E−03 |
| PC_dihomo-gamma-Linolenic | down | 0.846 | 3.8E−02 |
| acid (C20:cis[8,11,14]3) | | | |
| PC_Docosapentaenoic | down | 0.879 | 1.6E−02 |
| acid (C22:cis[4,7,10,13,16]5) | | | |
| PE_Palmitic acid (C16:0) | down | 0.900 | 4.9E−02 |
| PI_dihomo-gamma-Linolenic | down | 0.867 | 2.5E−02 |
| acid (C20:cis[8,11,14]3) | | | |
| SM_Sphingomyelin (d16:1, C23:0) | down | 0.804 | 1.4E−04 |
| SM_Sphingomyelin (d16:1, C24:0) | down | 0.827 | 1.3E−03 |
| SM_Sphingomyelin (d16:1, C24:1) | down | 0.875 | 3.4E−02 |
| SM_Sphingomyelin (d17:1, C23:0) | down | 0.899 | 1.3E−02 |
| SM_Sphingomyelin (d18:1, C23:0) | down | 0.879 | 2.0E−03 |
| SM_Sphingomyelin (d18:2, C18:0) | up | 1.050 | 4.3E−02 |
| SM_Sphingomyelin (d18:2, C23:0) | down | 0.889 | 3.4E−03 |
| TAG_Palmitic acid (C16:0) | up | 1.202 | 3.4E−02 |
| TAG_Hexadecenoic | up | 1.443 | 3.4E−02 |
| acid (C16:trans[9]1) | | | |
| TAG_Stearic acid (C18:0) | up | 1.791 | 1.7E−03 |
| TAG_Oleic acid (C18:cis[9]1) | up | 1.229 | 1.4E−02 |
| TAG_Linoleic acid (C18:cis[9,12]2) | up | 1.172 | 6.3E−03 |
| TAG_Eicosadienoic | up | 1.328 | 2.3E−02 |
| acid (C20:cis[11,14]2) | | | |
| TAG_Docosatetraenoic) | up | 1.792 | 1.1E−02 |
| acid (C22:cis[7,10,13,16]4 | | | |

TABLE 2a
Biomarkers from lipid analysis which are increased in MS patients
compared to healthy individuals

| | | Median | |
|---|---|---|---|
| | | of MS | |
| | | patients | |
| | Kind of | relative | |
| | regulation - | to | p-value |
| Metabolite | up | controls | of t-test |
| CE_Cholesterylester C18:0 | up | 1.210 | 4.0E−03 |
| CE_Cholesterylester C22:0 | up | 1.050 | 5.7E−03 |
| FFA_Palmitic acid (C16:0) | up | 1.385 | 8.5E−04 |
| FFA_Stearic acid (C18:0) | up | 1.248 | 5.2E−03 |
| FFA_Oleic acid (C18:cis[9]1) | up | 1.742 | 2.0E−04 |
| FFA_Linoleic acid (C18:cis[9,12]2) | up | 1.219 | 4.4E−04 |
| LPC_Palmitic acid (C16:0) | up | 1.065 | 2.7E−03 |
| LPC_Stearic acid (C18:0) | up | 1.221 | 5.8E−04 |
| SM_Sphingomyelin (d18:2, C18:0) | up | 1.050 | 4.3E−02 |
| TAG_Palmitic acid (C16:0) | up | 1.202 | 3.4E−02 |
| TAG_Hexadecenoic | up | 1.443 | 3.4E−02 |
| acid (C16:trans[9]1) | | | |
| TAG_Stearic acid (C18:0) | up | 1.791 | 1.7E−03 |
| TAG_Oleic acid (C18:cis[9]1) | up | 1.229 | 1.4E−02 |
| TAG_Linoleic acid (C18:cis[9,12]2) | up | 1.172 | 6.3E−03 |
| TAG_Eicosadienoic | up | 1.328 | 2.3E−02 |
| acid (C20:cis[11,14]2) | | | |
| TAG_Docosatetraenoic | up | 1.792 | 1.1E−02 |
| acid (C22:cis[7,10,13,16]4) | | | |

TABLE 2b
Biomarkers from lipid analysis which are decreased in MS patients
compared to healthy individuals

| | | Median | |
|---|---|---|---|
| | | of MS | |
| | | patients | |
| | Kind of | relative | |
| | regulation - | to | p-value |
| Metabolite | down | controls | of t-test |
| CE_Cholesterylester C24:6 | down | 0.825 | 3.1E−03 |
| PC_Myristic acid (C14:0) | down | 0.914 | 1.3E−02 |
| PC_Palmitic acid (C16:0) | down | 0.902 | 6.0E−03 |
| PC_Oleic acid (C18:cis[9]1) | down | 0.837 | 4.4E−03 |
| PC_dihomo-gamma-Linolenic | down | 0.846 | 3.8E−02 |
| acid (C20:cis[8,11,14]3) | | | |
| PC_Docosapentaenoic | down | 0.879 | 1.6E−02 |
| acid (C22:cis[4,7,10,13,16]5) | | | |
| PE_Palmitic acid (C16:0) | down | 0.900 | 4.9E−02 |
| PI_dihomo-gamma-Linolenic | down | 0.867 | 2.5E−02 |
| acid (C20:cis[8,11,14]3) | | | |
| SM_Sphingomyelin (d16:1, C23:0) | down | 0.804 | 1.4E−04 |
| SM_Sphingomyelin (d16:1, C24:0) | down | 0.827 | 1.3E−03 |
| SM_Sphingomyelin (d16:1, C24:1) | down | 0.875 | 3.4E−02 |
| SM_Sphingomyelin (d17:1, C23:0) | down | 0.899 | 1.3E−02 |
| SM_Sphingomyelin (d18:1, C23:0) | down | 0.879 | 2.0E−03 |
| SM_Sphingomyelin (d18:2, C23:0) | down | 0.889 | 3.4E−03 |

TABLE 3
Biomarkers which are altered in MS patients at active status in comparison
to MS patients at stable status

| | | Median | |
|---|---|---|---|
| | | of active | |
| | | lesion | |
| | | MS | |
| | | patients | |
| | Kind of | relative | |
| | regulation | to stable | |
| | (“up” or | MS | p-value |
| Metabolite | “down”) | patients | of t-test |
| Erythronic acid | down | 0.754 | 3.70E−02 |
| Indole-3-lactic acid | up | 1.177 | 3.50E−03 |
| 5-O-Methylsphingosine (*1) (*2) | down | 0.798 | 4.20E−03 |
| erythro-Sphingosine (*1) | down | 0.816 | 2.60E−03 |
| Eicosenoic acid (C20:cis[11]1) | down | 0.921 | 3.50E−02 |
| Hentriacontane | down | 0.821 | 2.20E−03 |
| Behenic acid (C22:0) | down | 0.856 | 1.40E−02 |
| erythro-Dihydrosphingosine (*1) | down | 0.8 | 2.50E−02 |
| Eicosanoic acid (C20:0) | down | 0.869 | 5.70E−03 |
| Cholestenol No 02 (*2) | down | 0.833 | 1.60E−03 |
| threo-Sphingosine (*1) | down | 0.859 | 1.30E−03 |
| 3-O-Methylsphingosine (*1) (*2) | down | 0.794 | 2.80E−03 |
| Tricosanoic acid (C23:0) | down | 0.813 | 1.20E−02 |
| Heneicosanoic acid (C21:0) | down | 0.834 | 7.70E−03 |
| Dehydroepiandrosterone sulfate | up | 1.467 | 1.40E−02 |
| Heptadecanoic acid (C17:0) | down | 0.757 | 7.10E−03 |
| Phosphatidylcholine (C18:0, C18:1) | down | 0.939 | 1.90E−02 |
| Phosphatidylcholine (C18:0, C18:2) | up | 1.012 | 3.80E−02 |
| Ceramide (d18:1, C24:1) | down | 0.783 | 2.20E−02 |
| Sphingomyelin (d18:1, C24:0) | down | 0.899 | 3.50E−03 |
| Eicosatrienoic acid | down | 0.861 | 7.80E−03 |
| (C20:cis[8,11,14]3) | | | |
| Tryptophan | up | 1.265 | 1.10E−02 |
| alpha-Tocopherol | down | 0.891 | 3.50E−02 |
| Glycerol phosphate, lipid fraction | down | 0.755 | 1.20E−02 |
| Lignoceric acid (C24:0) | down | 0.861 | 2.40E−02 |
| Stearic acid (C18:0) | down | 0.763 | 9.30E−03 |
| Phytosphingosine (*1) | down | 0.846 | 3.90E−02 |
| Androstenedione | up | 1.598 | 1.80E−03 |
| Linoleic acid (C18:cis[9,12]2) | down | 0.831 | 8.40E−03 |
| Nervonic acid (C24:cis[15]1) | down | 0.748 | 2.70E−03 |
| gamma-Linolenic acid | down | 0.7 | 1.50E−02 |
| (C18:cis[6,9,12]3) | | | |
| Total Cholesterol** | down | 0.843 | 6.30E−03 |
| Eicosapentaenoic acid | down | 0.623 | 8.00E−03 |
| (C20:cis[5,8,11,14,17]5) | | | |
| 1-Hydroxy-2-amino-(Z,E)-3,5- | down | 0.805 | 2.70E−02 |
| octadecadiene | | | |
| Sphingomyelin (d18:1, C23:0) - | down | 0.942 | 1.30E−02 |
| (MetID 68300022) | | | |
| Sphingomyelin (d18:2, C18:0) - | down | 0.901 | 1.40E−02 |
| (MetID 68300009) | | | |
| Phosphatidylcholine (C16:0, C20:5) - | down | 0.854 | 4.80E−02 |
| (MetID 68300048) | | | |
| Docosapentaenoic acid | down | 0.77 | 1.20E−02 |
| (C22:cis[7,10,13,16,19]5) - | | | |
| (MetID 28300493) | | | |
| Phosphatidylcholine (C18:0, C20:3) - | down | 0.905 | 2.20E−04 |
| (MetID 68300053) | | | |
| Cholesta-2,4,6-triene - | down | 0.781 | 4.60E−03 |
| MetID 28300521 | | | |
| Sphingomyelin (d18:2, C16:0) - | down | 0.914 | 2.10E−02 |
| MetID 68300007 | | | |

(*1) free and from sphingolipids;
(*2) see Table 5)
**Total Cholesterol comprising free and bound Cholesterol)

TABLE 3a
Biomarkers which are increased in MS patients at active status versus MS
patients at stable status

| | | Median of | |
|---|---|---|---|
| | | active | |
| | | lesion MS | |
| | | patients | |
| | Kind of | relative | |
| | regulation - | to stable | p-value of |
| Metabolite | up | MS patients | t-test |
| Indole-3-lactic acid | up | 1.177 | 3.50E−03 |
| Dehydroepiandrosterone sulfate | up | 1.467 | 1.40E−02 |
| Phosphatidylcholine | up | 1.012 | 3.80E−02 |
| (C18:0, C18:2) | | | |
| Tryptophan | up | 1.265 | 1.10E−02 |
| Androstenedione | up | 1.598 | 1.80E−03 |

TABLE 3b
Biomarkers which are decreased in MS patients at active status versus MS
patients at stable status

| | | Median of | |
|---|---|---|---|
| | | active | |
| | | lesion | |
| | | MS | |
| | | patients | |
| | Kind of | relative to | |
| | regulation - | stable MS | p-value |
| Metabolite | down | patients | of t-test |
| Erythronic acid | down | 0.754 | 3.70E−02 |
| 5-O-Methylsphingosine (*1) (*2) | down | 0.798 | 4.20E−03 |
| erythro-Sphingosine (*1) | down | 0.816 | 2.60E−03 |
| Eicosenoic acid (C20:cis[11]1) | down | 0.921 | 3.50E−02 |
| Hentriacontane | down | 0.821 | 2.20E−03 |
| Behenic acid (C22:0) | down | 0.856 | 1.40E−02 |
| erythro-Dihydrosphingosine (*1) | down | 0.8 | 2.50E−02 |
| Eicosanoic acid (C20:0) | down | 0.869 | 5.70E−03 |
| Cholestenol No 02 (*2) | down | 0.833 | 1.60E−03 |
| threo-Sphingosine (*1) | down | 0.859 | 1.30E−03 |
| 3-O-Methylsphingosine (*1) (*2) | down | 0.794 | 2.80E−03 |
| Tricosanoic acid (C23:0) | down | 0.813 | 1.20E−02 |
| Heneicosanoic acid (C21:0) | down | 0.834 | 7.70E−03 |
| Heptadecanoic acid (C17:0) | down | 0.757 | 7.10E−03 |
| Phosphatidylcholine (C18:0, | down | 0.939 | 1.90E−02 |
| C18:1) | | | |
| Ceramide (d18:1, C24:1) | down | 0.783 | 2.20E−02 |
| Sphingomyelin (d18:1, C24:0) | down | 0.899 | 3.50E−03 |
| Eicosatrienoic acid | down | 0.861 | 7.80E−03 |
| (C20:cis[8,11,14]3)) | | | |
| alpha-Tocopherol | down | 0.891 | 3.50E−02 |
| Glycerol phosphate, lipid fraction | down | 0.755 | 1.20E−02 |
| Lignoceric acid (C24:0) | down | 0.861 | 2.40E−02 |
| Stearic acid (C18:0) | down | 0.763 | 9.30E−03 |
| Phytosphingosine (*1) | down | 0.846 | 3.90E−02 |
| Linoleic acid (C18:cis[9,12]2) | down | 0.831 | 8.40E−03 |
| Nervonic acid (C24:cis[15]1) | down | 0.748 | 2.70E−03 |
| gamma-Linolenic acid | down | 0.7 | 1.50E−02 |
| (C18:cis[6,9,12]3) | | | |
| Total Cholesterol** | down | 0.843 | 6.30E−03 |
| Eicosapentaenoic acid | down | 0.623 | 8.00E−03 |
| (C20:cis[5,8,11,14,17]5) | | | |
| 1-Hydroxy-2-amino-(Z,E)-3,5- | down | 0.805 | 2.70E−02 |
| octadecadiene | | | |
| Sphingomyelin (d18:1, C23:0) - | down | 0.942 | 1.30E−02 |
| (MetID 68300022) | | | |
| Sphingomyelin (d18:2, C18:0) - | down | 0.901 | 1.40E−02 |
| (MetID 68300009) | | | |
| Phosphatidylcholine | down | 0.854 | 4.80E−02 |
| (C16:0, C20:5) - (MetID | | | |
| 68300048) | | | |
| Phosphatidylcholine | down | 0.77 | 1.20E−02 |
| (C16:0, C20:5) - (MetID | | | |
| 28300493) | | | |
| Phosphatidylcholine | down | 0.905 | 2.20E−04 |
| (C18:0, C20:3) ( - (MetID | | | |
| 68300053) | | | |
| Cholesta-2,4,6-triene - (MetID | down | 0.781 | 4.60E−03 |
| 28300521) | | | |
| Sphingomyelin (d18:2, C16:0) - | down | 0.914 | 2.10E−02 |
| (MetID 68300007) | | | |

(*1) free and from sphingolipids;
(*2) see Table 5)
**Total Cholesterol comprising free and bound Cholesterol)

TABLE 4
Lipid biomarkers which are altered in MS patients at active status versus
MS patients at stable status

| | | Median of | |
|---|---|---|---|
| | | active | |
| | | lesion MS | |
| | Kind of | patients | |
| | regulation | relative to | |
| | (“up” or | stable MS | p-value |
| Metabolite | “down”) | patients | of t-test |
| CE_Cholesterylester C16:0 | down | 0.941 | 2.4E−02 |
| CE_Cholesterylester C16:2 | down | 0.758 | 3.0E−02 |
| CE_Cholesterylester C18:2 | down | 0.939 | 2.8E−02 |
| CE_Cholesterylester C18:3 | down | 0.717 | 5.3E−03 |
| CE_Cholesterylester C18:4 | down | 0.613 | 3.0E−02 |
| CE_Cholesterylester C20:3 | down | 0.777 | 8.7E−03 |
| CE_Cholesterylester C20:4 | down | 0.856 | 3.9E−02 |
| CE_Cholesterylester C20:5 | down | 0.613 | 1.2E−02 |
| CE_Cholesterylester C20:6 | down | 0.569 | 1.5E−02 |
| CE_Cholesterylester C22:5 | down | 0.800 | 1.2E−02 |
| FS_Cholesterol | down | 0.783 | 2.4E−03 |
| FFA_Myristic acid (C14:0) | down | 0.568 | 4.2E−02 |
| FFA_Palmitic acid (C16:0) | down | 0.613 | 1.7E−02 |
| FFA_Stearic acid (C18:0) | down | 0.803 | 3.2E−02 |
| FFA_Oleic acid (C18:cis[9]1) | down | 0.542 | 2.0E−02 |
| FFA_Linoleic acid (C18:cis[9,12]2) | down | 0.563 | 1.0E−02 |
| FFA_Linolenic acid | down | 0.500 | 7.7E−03 |
| (C18:cis[9,12,15]3) | | | |
| PC_Stearic acid (C18:0) | down | 0.857 | 4.4E−03 |
| PC_dihomo-gamma-Linolenic | down | 0.849 | 2.3E−02 |
| acid (C20:cis[8,11,14]3) | | | |
| PC_Eicosapentaenoic | down | 0.778 | 3.9E−02 |
| acid (C20:cis[5,8,11,14,17]5) | | | |
| SM_Sphingomyelin (d16:1, C18:0) | down | 0.786 | 1.8E−02 |
| SM_Sphingomyelin (d16:1, C20:0) | down | 0.847 | 4.9E−02 |
| SM_Sphingomyelin (d17:1, C18:0) | down | 0.850 | 2.8E−02 |
| SM_Sphingomyelin (d17:1, C20:0) | down | 0.819 | 1.9E−02 |
| SM_Sphingomyelin (d18:0, C16:0) | down | 0.786 | 9.3E−03 |
| SM_Sphingomyelin (d18:1, C16:0) | down | 0.776 | 1.3E−02 |
| SM_Sphingomyelin (d18:1, C18:0) | down | 0.837 | 2.4E−02 |
| SM_Sphingomyelin (d18:1, C20:0) | down | 0.813 | 2.1E−02 |
| SM_Sphingomyelin (d18:1, C21:0) | down | 0.841 | 1.5E−02 |
| SM_Sphingomyelin (d18:1, C22:0) | down | 0.855 | 8.9E−03 |
| SM_Sphingomyelin (d18:1, C23:0) | down | 0.809 | 1.2E−02 |
| SM_Sphingomyelin (d18:1, C24:0) | down | 0.822 | 1.2E−02 |
| SM_Sphingomyelin (d18:1, C24:1) | down | 0.775 | 7.7E−03 |
| SM_Sphingomyelin (d18:2, C14:0) | down | 0.818 | 3.3E−02 |
| SM_Sphingomyelin (d18:2, C16:0) | down | 0.825 | 6.3E−03 |
| SM_Sphingomyelin (d18:2, C18:0) | down | 0.838 | 5.1E−03 |
| SM_Sphingomyelin (d18:2, C19:0) | down | 0.875 | 3.2E−02 |
| SM_Sphingomyelin (d18:2, C20:0) | down | 0.814 | 1.3E−02 |
| SM_Sphingomyelin (d18:2, C21:0) | down | 0.872 | 2.3E−02 |
| SM_Sphingomyelin (d18:2, C22:0) | down | 0.902 | 2.5E−02 |
| SM_Sphingomyelin (d18:2, C23:0) | down | 0.930 | 4.9E−02 |
| SM_Sphingomyelin (d18:2, C24:0) | down | 0.898 | 4.8E−02 |
| SM_Sphingomyelin (d18:2, C24:1) | down | 0.878 | 7.0E−03 |
| SM_Sphingomyelin (d18:2, C24:2) | down | 0.870 | 4.5E−02 |

Abreviations in Tables Referring to the Different Lipid Classes According to Example 1 (Determination of Metabolites):
CE Cholesterolesters
SM Sphingomyelins
FFA Free fatty acids
DAG Diacylglycerides
TAG Triacylglycerides
PI Phosphatidylinositols
PE Phosphatidylethanolamine
PC Phosphatidylcholines
LPC Lysophosphatidylcholines
FS Free sterols

Abbreviation Scheme for Fatty Acids:
C24:1: Fatty acid with 24 Carbon atoms and 1 double bond in the carbon skeleton.

TABLE 5
Additional chemical/physical properties of biomarkers marked with (*2) in the
tables above.

| Metabolite name | Description |
|---|---|
| 3-O-Methylsphingosine | 3-O-Methylsphingosine exhibits the following |
| | characteristic ionic fragments if detected with |
| | GC/MS, applying electron impact (EI) ionization |
| | mass spectrometry, after acidic methanolysis |
| | and derivatisation with 2% O- |
| | methylhydroxylamine-hydrochlorid in pyridine |
| | and subsequently with N-methyl-N- |
| | trimethylsilyltrifluoracetamid: |
| | MS (EI, 70 eV): m/z (%): 204 (100), 73 (18), 205 |
| | (16), 206 (7), 354 (4), 442 (1). |
| 5-O-Methylsphingosine | 5-O-Methylsphingosine exhibits the following |
| | characteristic ionic fragments if detected with |
| | GC/MS, applying electron impact (EI) ionization |
| | mass spectrometry, after acidic methanolysis |
| | and derivatisation with 2% O- |
| | methylhydroxylamine-hydrochlorid in pyridine |
| | and subsequently with N-methyl-N- |
| | trimethylsilyltrifluoracetamid: |
| | MS (EI, 70 eV): m/z (%): 250 (100), 73 (34), 251 |
| | (19), 354 (14), 355 (4), 442 (1). |
| Cholestenol No 02 | Cholestenol No 02 represents a Cholestenol |
| | isomer. It exhibits the following characteristic |
| | ionic fragments if detected with GC/MS, applying |
| | electron impact (EI) ionization mass spectrometry, |
| | after acidic methanolysis and derivatisation |
| | with 2% O-methylhydroxylamine- |
| | hydrochlorid in pyridine and subsequently with |
| | N-methyl-N-trimethylsilyltrifluoracetamid: |
| | MS (EI, 70 eV): m/z (%): 143 (100), 458 (91), 73 |
| | (68), 81 (62), 95 (36), 185 (23), 327 (23), 368 |
| | (20), 255 (15), 429 (15). |
| TAG (C18:1, C18:2) | TAG (C18:1, C18:2) represents the sum parameter |
| | of triacylglycerides containing the combination |
| | of a C18:1 fatty acid unit and a C18:2 |
| | fatty acid unit. If detected with LC/MS, applying |
| | electro-spray ionization (ESI) mass spectrometry, |
| | the mass-to-charge ratio (m/z) of the positively |
| | charged ionic species is 601.6 Da (+/− 0.5 |
| | Da). |
| Docosapentaenoic acid | Metabolite 28300490 exhibits the following |
| (C22:cis[4,7,10,13,16]5) - | characteristic ionic fragments when detected |
| (MetID 28300490( | with GC/MS, applying electron impact (EI) ionization |
| | mass spectrometry, after acidic methanolysis |
| | and derivatisation with 2% O- |
| | methylhydroxylamine-hydrochlorid in pyridine |
| | and subsequently with N-methyl-N- |
| | trimethylsilyltrifluoracetamid: |
| | MS (EI, 70 eV): m/z (%): 91 (100), 79 (96), 67 |
| | (94), 93 (57), 132 (54), 133 (52), 119 (46), 117 |
| | (44), 92 (43), 105 (35), 131 (33), 106 (31), 150 |
| | (30), |
| Docosapentaenoic acid | Metabolite 28300493 exhibits the following |
| (C22:cis[7,10,13,16,19]5) - | characteristic ionic fragments when detected |
| (MetID 28300493) | with GC/MS, applying electron impact (EI) ionization |
| | mass spectrometry, after acidic methanolysis |
| | and derivatisation with 2% O- |
| | methylhydroxylamine-hydrochlorid in pyridine |
| | and subsequently with N-methyl-N- |
| | trimethylsilyltrifluoracetamid: |
| | MS (EI, 70 eV): m/z (%): 79 (100), 91 (67), 67 |
| | (66), 93 (55), 55 (46), 105 (46), 80 (45), 94 (32), |
| | 119 (30), 77 (30), 108 (29), 69 (23), 117 (22), |
| | 131 (19) |
| Cholesta-2,4,6-triene - (MetID | Metabolite 28300521 exhibits the following |
| 28300521) | characteristic ionic fragments when detected |
| | with GC/MS, applying electron impact (EI) ionization |
| | mass spectrometry, after acidic methanolysis |
| | and derivatisation with 2% O- |
| | methylhydroxylamine-hydrochlorid in pyridine |
| | and subsequently with N-methyl-N- |
| | trimethylsilyltrifluoracetamid: |
| | MS (EI, 70 eV): m/z (%): 366 (100), 135 (96), |
| | 143 (74), 247 (45), 95 (41), 117 (39), 81 (38), 91 |
| | (37), 141 (36), 145 (34), 142 (30) |
| Glutamine - (MetID 38300144) | Metabolite 38300144 exhibits the following |
| | characteristic ionic fragments when detected |
| | with GC/MS, applying electron impact (EI) ionization |
| | mass spectrometry, after acidic methanolysis |
| | and derivatisation with 2% O- |
| | methylhydroxylamine-hydrochlord in pyridine |
| | and subsequently with N-methyl-N- |
| | trimethylsilyltrifluoracetamid: |
| | MS (EI, 70 eV): m/z (%): 73 (100), 155 (77), 147 |
| | (27), 75 (22), 229 (20), 100 (13), 156 (10), 84 |
| | (10), 139 (9) |
| Lysophosphatidylethanolamine | Metabolite 68300002 exhibits the following |
| (C22:5) - (MetID 68300002) | characteristic ionic species when detected with |
| | LC/MS, applying electro-spray ionization (ESI) |
| | mass spectrometry: mass-to-charge ratio (m/z) |
| | of the positively charged ionic species is 528.2 |
| | (+/−0.5). |
| Sphingomyelin (d18:2, C16:0) - | Metabolite 68300007 exhibits the following |
| (MetID 68300007) | characteristic ionic species when detected with |
| | LC/MS, applying electro-spray ionization (ESI) |
| | mass spectrometry: mass-to-charge ratio (m/z) |
| | of the positively charged ionic species is 723.6 |
| | (+/−0.5). |
| Sphingomyelin (d18:2, C18:0) - | Metabolite 68300009 exhibits the following |
| (MetID 68300009) | characteristic ionic species when detected with |
| | LC/MS, applying electro-spray ionization (ESI) |
| | mass spectrometry: mass-to-charge ratio (m/z) |
| | of the positively charged ionic species is 729.8 |
| | (+/−0.5). |
| Sphingomyelin (d18:1, C23:0) - | Metabolite 68300022 exhibits the following |
| (MetID 68300022) | characteristic ionic species when detected with |
| | LC/MS, applying electro-spray ionization (ESI) |
| | mass spectrometry: mass-to-charge ratio (m/z) |
| | of the positively charged ionic species is 801.8 |
| | (+/−0.5). |
| TAG (C16:0, C18:1, C18:2) - | Metabolite 68300031 exhibits the following |
| (MetID 68300031) | characteristic ionic species when detected with |
| | LC/MS, applying electro-spray ionization (ESI) |
| | mass spectrometry: mass-to-charge ratio (m/z) |
| | of the positively charged ionic species is 857.8 |
| | (+/−0.5 |
| Phosphatidylcholine | Metabolite 68300048 exhibits the following |
| (C16:0, C20:5) - (MetID | characteristic ionic species when detected with |
| 68300048) | LC/MS, applying electro-spray ionization (ESI) |
| | mass spectrometry: mass-to-charge ratio (m/z) |
| | of the positively charged ionic species is 780.8 |
| | (+/−0.5). |
| Phosphatidylcholine | Metabolite 68300053 exhibits the following |
| (C18:0, C20:3) - (MetID | characteristic ionic species when detected with |
| 68300053) | LC/MS, applying electro-spray ionization (ESI) |
| | mass spectrometry: mass-to-charge ratio (m/z) |
| | of the positively charged ionic species is 812.6 |
| | (+/−0.5). |
| TAG (C16:0, C18:1, C18:3) - | Metabolite 68300057 exhibits the following |
| (MetID 68300057) | characteristic ionic species when detected with |
| | LC/MS, applying electro-spray ionization (ESI) |
| | mass spectrometry: mass-to-charge ratio (m/z) |
| | of the positively charged ionic species is 855.6 |
| | (+/−0.5). |

1. A method for diagnosing multiple sclerosis in a subject comprising the steps of:
a) determining in a sample of a subject an amount of at least one biomarker selected from the group consisting of the biomarkers listed in Table 1 and/or Table 2;
b) comparing the amount of the at least one biomarker to a reference amount, whereby multiple sclerosis is to be diagnosed.

2. The method of claim 1, wherein the at least one biomarker is selected from the group consisting of the biomarkers listed in Table 1a and/or Table 2a, and wherein an increase in the at least one biomarker is indicative for multiple sclerosis.

3. The method of claim 1, wherein the at least one biomarker is selected from the group consisting of the biomarkers listed in Table 1b and/or Table 2b, and wherein a decrease in the at least one biomarker is indicative for multiple sclerosis.

4. The method of claim 1, wherein said reference amount is derived from an apparently healthy subject.

5. A method for identifying whether a subject is in need of a therapy of multiple sclerosis, comprising diagnosing multiple sclerosis in a subject by the method of claim 1, and identifying a subject in need of a therapy of multiple sclerosis if multiple sclerosis is diagnosed.

6. A method for determining whether a multiple sclerosis therapy is successful comprising the steps of:
a) determining at least one biomarker selected from the group consisting of the biomarkers listed in Table 1, 2, 3 and/or 4 in a first and a second sample of the subject, wherein said first sample has been taken prior to or at the onset of a multiple sclerosis therapy, and said second sample has been taken after the onset of said therapy; and
b) comparing the amount of said at least one biomarker in the first sample to the amount in the second sample, whereby a change in the amount determined in the second sample in comparison to the first sample is indicative for multiple sclerosis therapy being successful.

7. The method of claim 6, wherein said change is a decrease and wherein said at least one biomarker is selected from the group consisting of the biomarkers listed in Table 1a and/or 2a.

8. The method of claim 6, wherein said change is an increase and wherein said at least one biomarker is selected from the group consisting of the biomarkers listed in Table 1b and/or 2b.

9. The method of claim 5, wherein said therapy comprises administration of at least one drug selected from the group consisting of: Interferon Beta1a, Interferon Beta 1b, Azathioprin, Cyclophosphamide, Glatiramer Acetate, Immunglobuline Methotrexat, Mitoxantrone, Leustatin, IVIg, Natalizumab, Teriflunomid, Statins, Daclizumab, Alemtuzumab, Ritximab, Sphingosin 1 phosphate antagonist Fingolimod (FTY720), Cladribine, Fumarate, Laquinimod, drugs affecting B-cells, and antisense agents against CD49d.

10. A method for diagnosing an active status of multiple sclerosis in a subject comprising the steps of:
a) determining in a sample of a subject an amount of at least one biomarker selected from the group consisting of the biomarkers listed in Table 3 and/or Table 4; and
b) comparing the amount of said at least one biomarker to a reference amount, whereby multiple sclerosis is to be diagnosed.

11. The method of claim 10, wherein the at least one biomarker is selected from the group consisting of the biomarkers listed in Table 3a and wherein an increase in the at least one biomarker is indicative for an active status of multiple sclerosis.

12. The method of claim 10, wherein the at least one biomarker is selected from the group consisting of the biomarkers listed in Table 3b and Table 4, and wherein a decrease in the amount of the at least one biomarker is indicative for an active status of multiple sclerosis.

13. The method of claim 10, wherein said reference amount is derived from a subject exhibiting a stable status of multiple sclerosis.

14. A method for predicting whether a subject is at risk of developing multiple sclerosis comprising the steps of:
a) determining in a sample of a subject an amount of at least one biomarker selected from the group consisting of the biomarkers listed in Table 1 and/or 2; and
b) comparing the amount of said at least one biomarker to a reference amount, whereby it is predicted whether said subject is at risk of developing multiple sclerosis.

15. A method for predicting whether a subject is at risk of developing an active status of multiple sclerosis comprising the steps of:
a) determining in a sample of a subject an amount of at least one biomarker selected from the group consisting of the biomarkers listed in Table 3 and/or 4; and
b) comparing the amount of said at least one biomarker to a reference amount, whereby it is predicted whether said subject is at risk of developing an active status of multiple sclerosis.
